(19) United States
(12) Patent Application Publication
(10) Pub. No.: US 2003/0220829 A1
(43) Pub. Date: Nov. 27, 2003

(54) Method and system for allocating workers

(76) Inventor: Jonathon Seally, Watsons Bay (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/401,201

(22) Filed: Mar. 27, 2003

(30) Foreign Application Priority Data
Mar. 28, 2002 (AU) PS 1455

(51) Int. Cl. G06F 17/60

(52) U.S. Cl. 705/9; 709/217

(57) ABSTRACT

The present invention relates to a method of allocating locums to available medical shifts, each shift involving specified work at a respective entity over a predetermined time period. The method utilizes a base station adapted to receive a shift request from a remote end station and access shift data stored in a store, the shift data representing respective available shifts. The base station provides an indication of one or more available shifts to the end station in response to the shift request, with the end station providing a shift selection indicating at least a selected shift the locum wishes to work. The base station responds to the shift selection to assign the locum to the shift by modifying the shift data in accordance with the received shift selection to indicate that the shift is no longer available and transferring an indication of the shift selection to the entity.

### BACKGROUND OF THE INVENTION

This invention is directed to a method and system for allocating temporary workers to an available shift. More particularly, this invention is directed to a method and system for allocating locums to vacant medical shifts, such as physician shifts.

Currently, if a hospital or other health care provider requires a health professional to work an upcoming shift or series of shifts, the hospital administration will contact, usually by telephone or facsimile, one or more medical personnel agencies. These agencies will in turn notify their staff, who are typically locum workers, of the available work and try to fill the shift for the hospital.

However, this system includes a number of drawbacks. First, it is typical for the hospital to contact only one or a limited number of personnel agencies. This can happen for a number of reasons, such as time constraints or the fact that the hospital only has a relationship with a small number of agencies. As a result, the number of locums that are aware of the available shifts will be relatively small, thereby reducing the chance of a suitable locum being located to cover the shift.

As the hospital has to contact each agency separately, this is generally inefficient and tine consuming for both the hospital and agency. This is exacerbated by the fact that an agency may spend time looking for staff when the shit has already been filled by another agency.

The data received by an agency from the various hospitals is usually inconsistent and will vary from hospital to hospital. Furthermore, each agency may require different information, thereby further complicating the situation.

The locum shift workers do not receive a uniform notification of available shifts from an agency because one agency does not have access to all shifts available, and there is variation in information provided from one hospital to another hospital, and between agencies. As a result of this, shifts regularly go unfilled because not enough locum workers are notified of the available shifts.

There is very little competition between agencies for any one hospital's shifts, and as a result, the labor intensive nature of the current process and administrative costs are high for both the agency and the hospital. Another problem is that there is very little opportunity for a hospital to try and fill shifts directly with the locum shift worker outside of an agency if the hospital so desired. Further, there is no logging or accountability for either the hospital or the agency. In addition, there is no reporting generated for the hospital other than the invoices sent by the agencies used in the billing period and no summary reporting for the agencies. Finally, all actions, such as a hospital listing a new shift with an agency or an agency filling a shift with a worker, can only be performed during regular business hours.

A number of web-based system have also been proposed for matching potential candidates to jobs, thereby allowing a large number of candidates to be aware of the job. An example of such a system is a system which allows employers to enter details of vacant positions on a web page. Individuals are then able to access the job description and indicate an interest in the job to the employer. This ensures that the employer is able to advertise to and hence receive a large number of applicants for the position. This system effectively advertises available positions but does not aid the employer in determining if the candidates are suitable for the position.

As a result, this makes the system unsuitable for use in matching locums to vacant shifts for many reasons. First, the hospitals are not interested in receiving a large number of potential candidates for a vacant shift. Secondly, it is important that the shift is filled which would not necessarily be achieved with such a system. There is no procedure that would allow the system to ensure that the shift is filled with a suitable candidate other than by having the employer perform checks. Furthermore, the system does not require the employer to enter specific information, and as a result the information displayed on the website will generally be inconsistent, varying depending on who supplied the information. This can make it difficult for users of the system to determine if an advertised position is suitable for them, which is particularly important when assigning locums to vacant medical shifts. Finally, such a system does not automatically remove details of jobs when the position has been filled which results in individuals applying for positions that are already filled.

There is a need for an improved method and system for allocating temporary workers to an available shift.

### SUMMARY OF THE INVENTION

In accordance with the present invention, there is provided a method and system for allocating temporary workers to an available shift.

Further, in accordance with the present invention, there is provided a method and system for allocating locums to an available medical shift, wherein each shift involves specified work at a specified entity over a predetermined period of time.

Further, in accordance with the present invention, there is provided a method and system for allocating at least one locum to an available shift using a distributed computing system. The method and system comprising the steps of and means adapted for: receiving a shift request from a remote user, and accessing selected shift data stored in a memory, the shift data representative of at least one shift, wherein the shift data includes at least one of an entity associated with each shift, a predetermined time period for each shift, and specified work associated with each shift. The method and system further comprise the steps of and means adapted for determining the availability of at least one shift in response to the shift request based on the shift data, transmitting the availability of at least one shift to the remote user, receiving at least one shift selection from the remote user, and assigning a locum to the shift in accordance with the received shift selection. The method and system also comprises the steps of and means adapted for modifying the shift data in accordance with the received shift selection to indicate the shift is no longer available and transmitting the received shift selection and assigned locum information to at least one of the entity associated with the shift selection and the remote user.

In a preferred embodiment, the method and system further comprise the steps of and means adapted for receiving selected information about a shift from the entity associated with the shift, and generating shift data for such shift in accordance with the received information.

In another preferred embodiment, the method and system further comprise the steps of and means adapted for receiving selected information about a locum from the remote user; transmitting the selected information about the locum with the received shift selection and assigned locum to the entity; determining, by the entity, if the entity accepts the assigned locum based on the selected information about the locum; transmitting the entity determination of whether the entity accepts the assigned locum to at least one of the memory and the remote user; if the entity does not accept the assigned locum, modifying the shift data to indicate the shift is available; and if the entity does accept the assigned locum, modifying the shift data to indicate the shift has been filled.

In still another preferred embodiment, the method and system further comprise the steps of and the means adapted for receiving selected user information from a remote user, and accessing selected locum data stored in a memory in response to the received user information, the locum data representative of at least one locum and including selected data associated with each locum.

In another preferred embodiment, the method and system further comprise the steps of and the means adapted for receiving selected locum information from a remote user in connection with a shift request; determining the availability of at least one shift in response to at least one of the received locum information, received shift request, and locum data; and transmitting the availability of at least one shift to the remote user.

In one more preferred embodiment, the method and system further comprise the steps of and means adapted for receiving data from the remote user if the assigned locum is able to work the selected shift; if the received data indicates that the assigned locum is unable to work the selected shift, accessing selected locum data, the locum data representative of at least one locum and including selected data associated with each locum accessing locum data; determining an alternative locum to be assigned to the selected shift based on the locum data; and transmitting information about the alternate locum to at least one of the remote user and the entity associated with the shift.

These and other advantages and aspects of the present invention will be appreciated by one skilled in the art upon reading and understanding the specification.

### BRIEF DESCRIPTION OF THE DRAWINGS

Preferred embodiments of the invention will now be described, by way of example only, with reference to the accompanying drawings in which:

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is a flow chart of the process implemented by the system of FIG. 1;

FIGS. 5A, 5B, and 5C are a flow chart of the process implemented by the system of FIG. 1;

FIGS. 6A and 6B are a flow chart of the log-on procedure implemented by the system of FIG. 1;

FIG. 7 is an example of a form used by the entity for providing shift details; and,

FIG. 8 is an example of a screen presenting shift details of a number of shifts to a user of on of the remote or end stations.

### DETAILED DESCRIPTION OF THE PREFERRED EMBODIMENTS

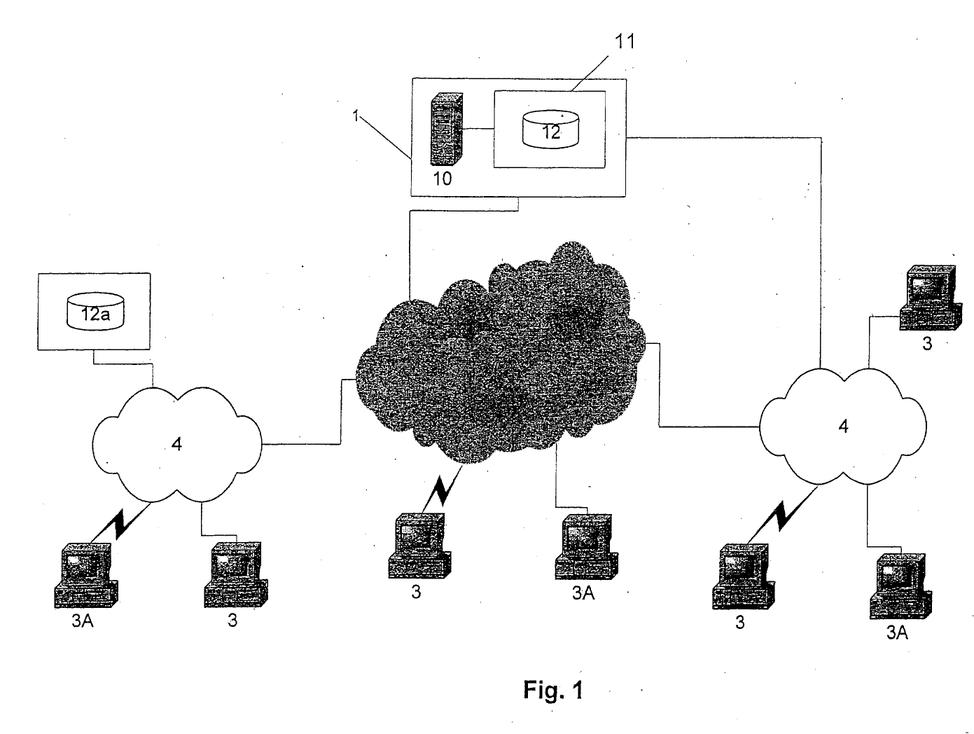

The present invention is directed to a method and system for allocating temporary workers to an available shift using a distributed computing system. An example of the present invention will now be described with reference to FIG. 1, which shows a system suitable for implementing the present invention. As shown, the system includes a base station 1 coupled to a number of remote or end stations 3, via a communications network 2, and/or via a number of local area networks (LANs) 4. The base station 1 is generally formed from one or more processing systems 10 coupled to a data store 11, the data store 11 usually including a database 12, as shown. Preferably the database 12 is a relational database.

In use, users of the end stations 3 suitably access information regarding vacant shifts that have been posted by entities such as medical institutions, hospitals, or the like, using the remote or end stations 3A. It will therefore be appreciated that the system may be implemented using a number of different architectures. However, in this example, the communications network 2 is the Internet 2, with the LANs 4 representing private LANs, such internal LANs within a company or other suitable means.

In this case, the services provided by the base station 1 are generally made accessible via the Internet 2, and accordingly, the processing systems 10 may be capable of generating web-pages or like that can be viewed by the users of the end stations 3.

In addition to vacant shift information being transferred from the end stations 3A via the Internet 2, the information is suitably also be transferred using other suitable techniques known in the art, such as transferring data in a hard, or printed format, as well as transferring the data electronically on a physical medium, such as a floppy disk, CD-ROM, or other suitable means.

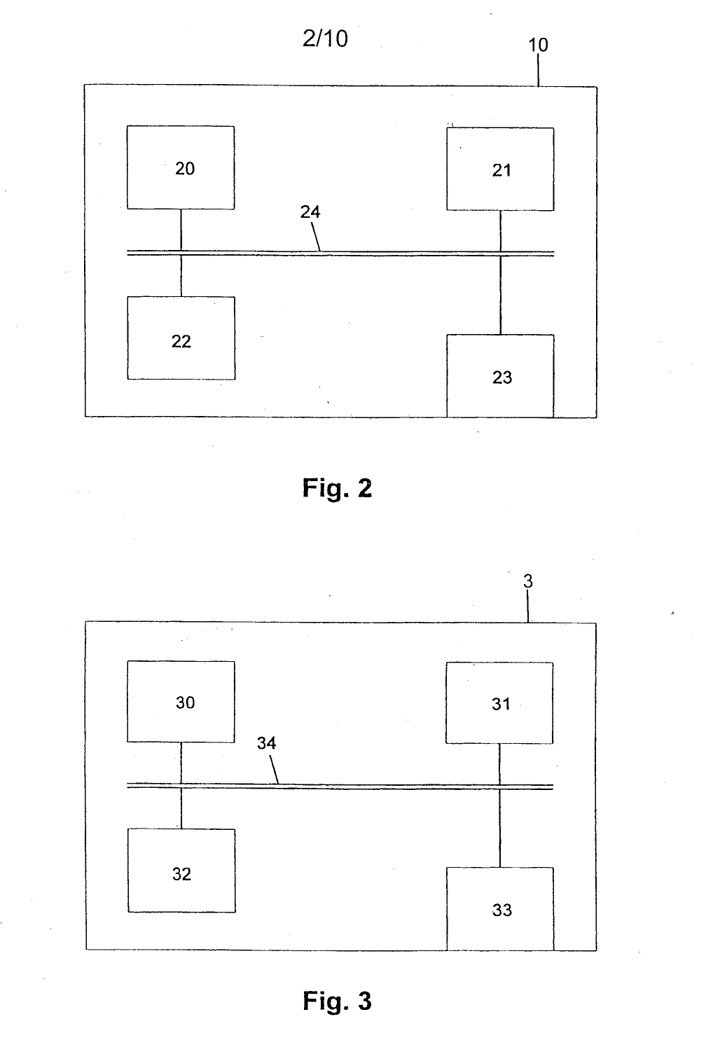

In any event, the processing systems 10 may be any form of processing system known in the art, but typically includes a processor 20, a memory 21, an input/output (I/O) device 22 and an interface 23 coupled together via a bus 24, as shown in FIG. 2. The interface 23, which may be a network interface card, or other suitable means, is used to couple the processing system to the Internet 2.

It will therefore be appreciated that the processing system 10 may be formed from any suitable processing system which is capable of operating applications software to respond to data requests from the end stations 3, 3A, which may be achieved by the generation of suitable web pages, or other suitable means. However, in general the processing system 10 will be formed from a server, such as a network server, web-server, or other suitable means.

Similarly, the end stations 3, 3A must generally be capable of co-operating with the base station 1 to allow browsing of web-pages, or the transfer of data in other manners. Accordingly, in this example, as shown in FIG. 3, the end stations 3, 3A are formed from a processing system including a processor 30, a memory 31, an input/output (I/O) device 32 and an interface 33 coupled together via a bus 34. The interface 33, which may be a network interface card, or other suitable means, is used to couple the end station 3, 3A to the Internet 2.

It will be therefore be appreciated that the end station 3, 3A may be formed from any suitable processing system, such as a suitably programmed PC, Internet terminal, lap top, hand-held PC, or the like, which is typically operating applications software to enable web-browsing or other suitable means.

Alternatively, the end station 3, 3A is suitably formed from specialized hardware, such as an electronic touch sensitive screen coupled to a suitable processor and memory. In addition to this, the end station 3, 3A is suitably adapted to connect to the Internet 2, or the LANs 4 via wired or wireless connections. It is also feasible to provide a direct connection between the base stations 1 and the end stations 3, 3A, for example if the system is implemented as a peer-2-peer network.

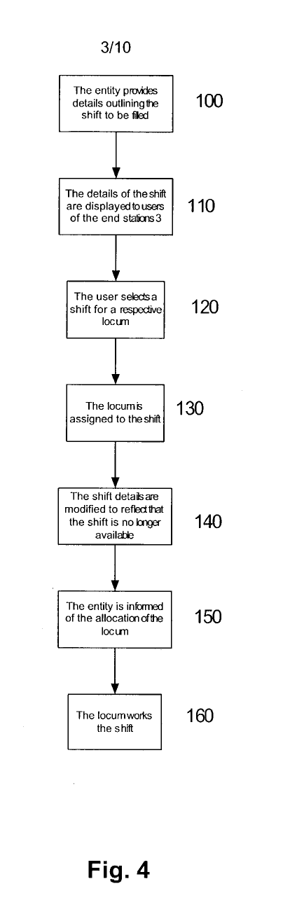

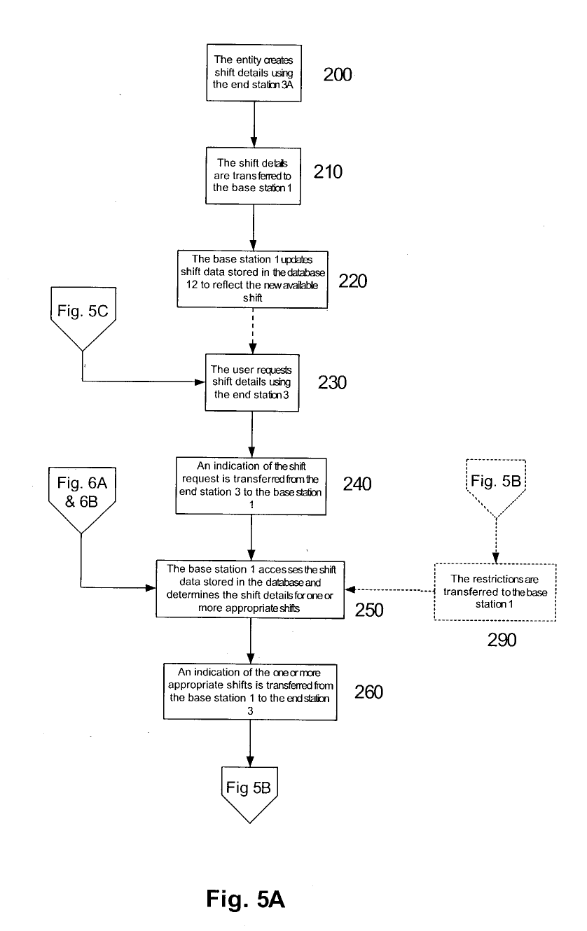

An overview of this operation of the invention will now be described with reference to FIG. 4. The system operates by allowing entities, such as medical institutions, or the like, to provide details of vacant shifts to the base station 1, at step 100. The shift details outlining the vacant shifts or data associated with each vacant shift are then displayed to users of the end stations 3 at step 110, allowing the vacant shifts to be filled by a locum or other temporary worker.

In this regard, locums will be taken to mean any medical worker that is available for working temporary shifts. This will therefore include doctors, nurses, allied health workers, or the like, as will be appreciated by those skilled in the art.

It will therefore be appreciated that the users of the end stations 3 may be either the locums themselves, or alternatively may be an agency that arranges locum placement, or the like. In the first case, the locums simply select a shift for themselves, whereas in the second case, the agency accepts the shift on behalf of a locum they know is available and willing to work the shift.

In any event, once the shift has been selected on behalf of a locum at step 120, the locum is assigned to the shift at step 130 by any suitable means. The shift details are modified at step 140 by any suitable means to reflect the fact that the shift is no longer available, thereby preventing the shift being located during any subsequent shift searches. This in turn prevents other users from locating and trying to accept the shift. This process is automatic in the sense that the base station 1 assigns the locum to the shift without any manual intervention, as soon as the shift is selected either by or on behalf of the locum. It will be appreciated that the system therefore operates to assign the locums or temporary workers to shifts on a first come first serve basis.

The entity is informed of the allocation of the locum at step 150 by any suitable means, with the locum working the shift as required at step 160.

As will be explained in more detail below, it is necessary for the locum to be suitable to work the assigned shift. Accordingly, the process will also involve checking the locum's details or data associated with each locum to determine if they are acceptable for the position. In particular, it will be appreciated that the locum may require certain capabilities in order to perform the work that will occur during the shift. Thus, for example, it is typical for the shift to require a locum having predetermined qualifications, experience, or the like.

In order to achieve this, the entity is able to define criteria outlining any qualification, experience or other requirements that the locum must satisfy in order to work the shift. The locum's details are then checked, either by the base station 1 or an external agency, as will be described in more detail below, to ensure that the locum satisfies the specified criteria.

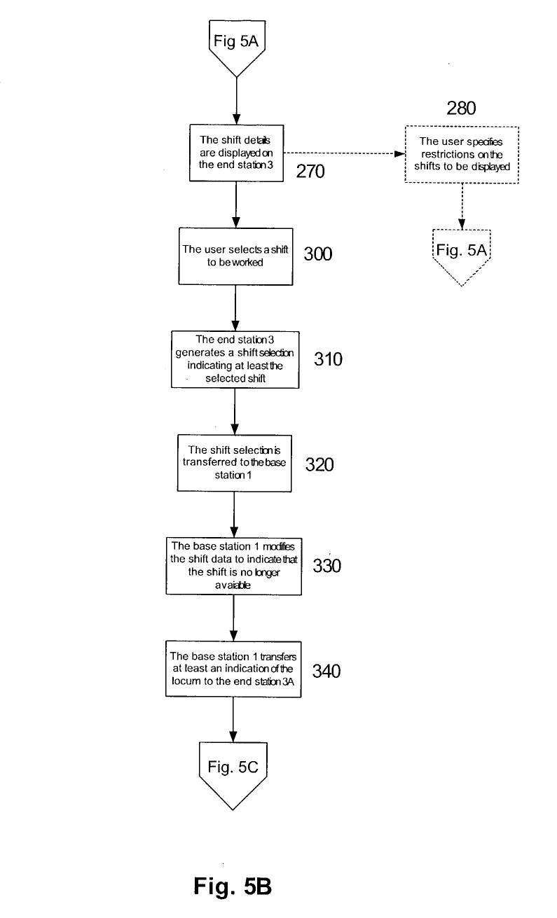

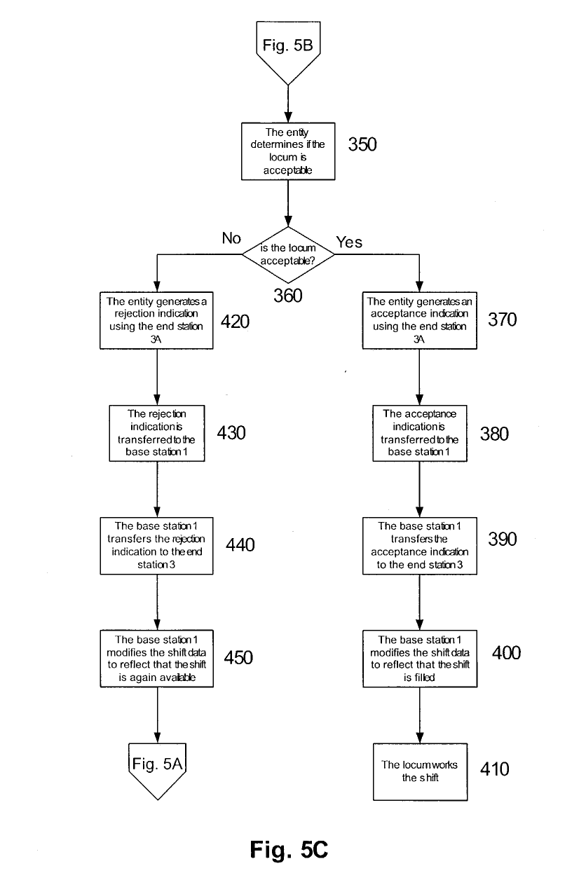

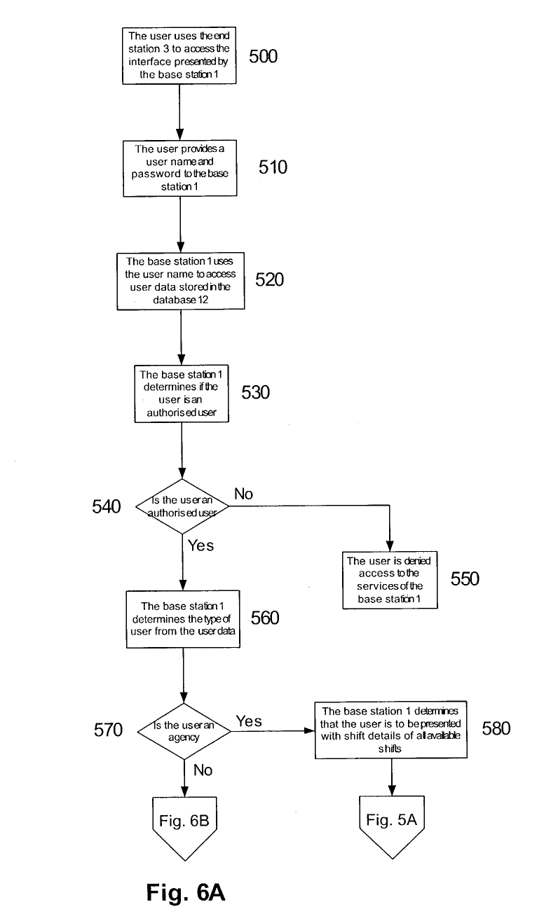

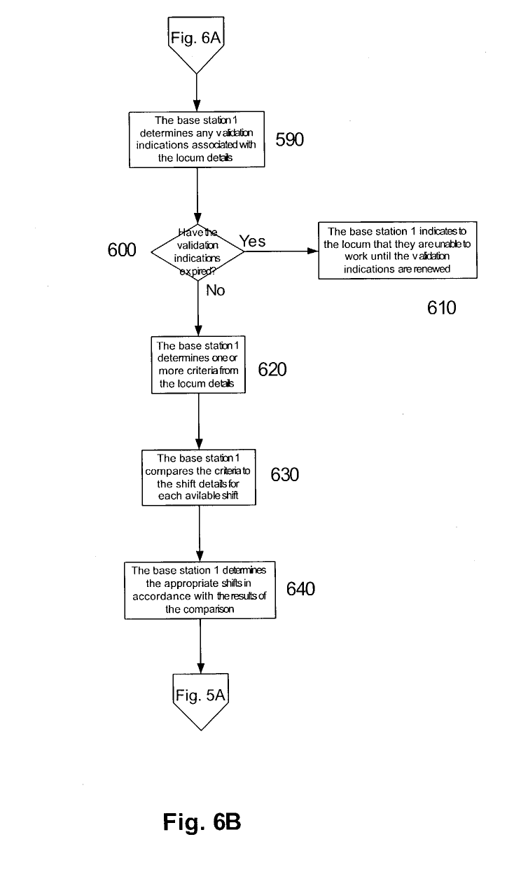

A detailed example of the manner in which this is achieved will now be described with reference to FIGS. 5 and 6.

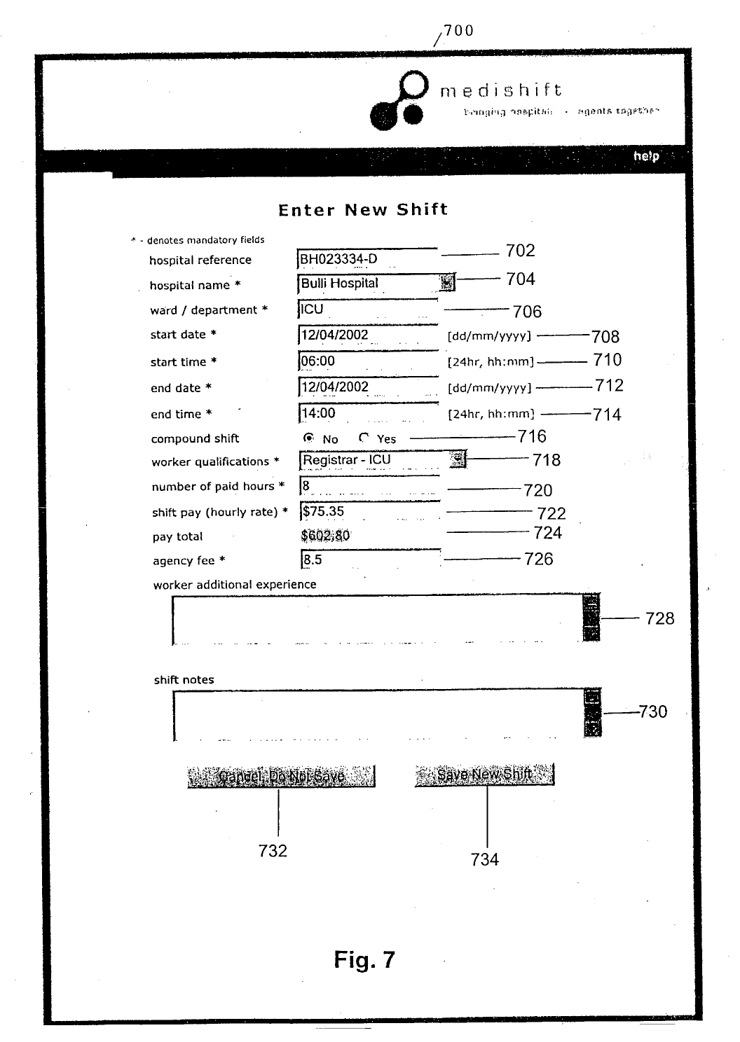

As shown in FIG. 5A, the entity, such as a hospital, medical institution, private clinic, or the like, creates shift details using the end station 3A, at step 200 by any suitable means. Preferably, in order to achieve this, end station 3A may be running a specialized applications software as known in the art that allows users to enter the details or data associated with the shift. Alternatively, the end station 3A suitably accesses web pages generated by the base station 1 by any suitable means. In either case, the entity will typically be presented with a form prompting the entity for certain details regarding the shift. An example of which is shown in FIG. 7.

As shown the form 700 includes a number of fields that therefore constrains the entity to provide specific information regarding the shift. This ensures that sufficient information is available regarding each shift to allow users to determine if a prospective locum is able to work the shift. Additionally it ensures that the information is made available in a consistent manner allowing the base station 1 to handle the shift details in an automated fashion, as well as making the shift details easier to understand.

The shift details will typically include details concerning the time and location of the shift, thereby allowing users to determine whether the shift is suitable for a prospective locum. For example the shift details will include:

Shift Start Date 708 and Time 710

Shift End Date 712 and Time 714

Whether it is a compound shift 716

Shift Pay (hourly rate) 722

Shift Notes 730

Agency Fee (as a %) 726

Pay details including the number of hours 720 and rate 724

Entity details including the medical facility reference number 702, name 704, and ward 706

In addition to this, the shift details will typically include criteria that are used to specify minimum requirements for the locum to be capable of working the shift (not shown). The criteria may include requirements relating to, for example: qualifications, certification, experience level, availability for on call, criminal records, and specific procedural medical skills required.

An example of the specific procedural medical skills that a locum, such as a doctor, may have is shown in Appendix A. In order to allow information provided about the locum and the information provided by the hospital to be compared by the base station 1, the qualifications may be selected from a drop down list or the like, thereby ensuring that both the locum and entity use the same terminology to refer to the same qualifications. Additional procedural medical skills may be listed in a free text field 728. Again, this could be achieved using a pre-set format to allow comparison by the base station 1. Once the user has entered the required information, the user may select the Save New Shift button 734 to save the information. If the user does not want to save the information, the user may select the Cancel, Do Not Save button 732.

The shift notes section of the shift details can also include additional information regarding the shift, such as the availability of accommodation, or similar information.

In general, the entity would be required to register with the system before being able to submit details of a shift for inclusion on the system. It will therefore be appreciated that the entity would typically have to undergo a registration procedure via any suitable means, during which the entity would supply various details regarding the entity, such as the location, billing arrangements, and any other special requirements. In addition to this, the entity can define default settings for certain information by any suitable means, such as the hospital location information, such that this information does not need to be submitted with each shift, and instead can be added to the shift details from appropriate entity data stored in the database 12.

This technique of specifying information once during registration is particularly beneficial when considering different requirements, and in particular, the Procedural Medical Skills for various shifts. In particular, the entity, when registering, will be provided with a guide outlining the different skills a locum with a respective qualification is expected to have. This then allows the entity to create modified definitions for some circumstances.

Thus for example, in the emergency or intensive care wards, locums generally have to be more capable than equivalent locums on other wards. This happens because of the additional expectations associated with these high care situations. Thus, an entity may determine that an RMO 2 qualified locum would need additional procedural medical skills, such as the ability to perform IV cannulation, in addition to the normal skills associated with an RMO 2 locum.

The relevance of any of the specific procedural medical skills will generally depend on the ward in which the locum is to work, the entity, and whether the shift is a day or night shift (primarily because the locum will have less supervision at night). Accordingly, the entity is provided with the option of modifying the different skill sets of different levels of qualification depending on the ward and the time of the shift.

Thus the entity specifies for each level of qualification, any additional medical procedural requirements for each level of qualification. These requirements represent additional requirements beyond those included in the guide, which represent the different skills a locum with a respective qualification can be expected to have. This is repeated for each qualification level, for each ward and for day or night shifts.

This is achieved by having a form including check boxes for each of the different procedural requirements. The entity specifies selected qualifications and shift locations, such as RMO 2 intensive care shifts, and selects the appropriate additional procedural requirements using the check boxes. Thus for example, the entity will specify RMO 2 intensive care shifts, and then select a check box corresponding to IV cannulation.

Thus, to enter shift details, an operative of the entity will be provided with a form on the display of the end station 3A that allows the operative to select different shift times, and locations. The operative will then select an appropriate qualification from the drop down list. This information is then transferred to the base station 1 and saved with the entity data in the database 12.

When the entity submits shift details by any suitable means, the base station 1 will examine the entity data and check the level of the qualification required. Thus, for example, if the shift location is in the intensive care ward, the entity data may indicate that an RMO 2 locum also requires experience of IV cannulation. Accordingly, the base station 1 will ensure that any locum assigned to such a shift has the required IV cannulation experience, in addition to the usual RMO 2 experience, as will be described in more detail below.

In any event, it will be appreciated from this, that this effectively allows the entities to create tailored definitions of the qualifications to ensure that suitable workers are obtained. Furthermore, these definitions need only be created once when the entity data is created, thereby obviating the need for the operative to consider additional requirements each time details of a shift are entered.

It is of course possible to specify further requirements for each shift in the free text field, as outlined above.

In any event, once the shift details have been created, the details are transferred to the base station 1 at step 210 by any suitable means. The base station 1 uses the shift details to update shift data stored in the database 12 by any suitable means, to thereby reflect the new available shift at step 220.

At step 230, a user of the system generates a shift request using the end station 3 by any suitable means. The shift request is then transferred from the end station 3 to the base station 1 at step 240 by any suitable means, allowing the base station to access shift data and determine details of one or more appropriate shifts by any suitable means at step 250.

It will be appreciated, that is typically achieved by having the user access a web page generated by the base station 1, using the end station 3. In order to do this, the user will generally have to register with the system to obtain a user name and password by any suitable means. In the case of the user being a locum, the locum will have to provide locum details by any suitable means that are required to determine if the locum is acceptable for available shifts.

Accordingly, the locum will be asked to provide general information, such as name, address and contact information. The locum will also be asked to provide details that can be used in assessing the ability of the locum to work shifts. This will generally include information such as: qualifications, certification levels, work experience, details of any police record, and specific procedural medical skills.

As the shift details themselves are well defined by virtue of the manner in which the shift data is provided, the locums can be asked to provide very specific details regarding experience and specific procedural medical skills, as shown, for example, in Appendix A.

In contrast, in the case of an agency, the checking of a locum's qualifications or the like is generally done by the agency itself, in which case there is no need to provide such details at this early stage. Even so, in this instance, the agency itself will have at least some details of the locum, thereby allowing the agency to perform its own checks of the locum.

As an alternative however, the agency may provide locum details to the base station 1, to allow the base station 1 to check the locum details, as will be described in more detail below.

Once a user name and password is assigned, the users can then log-on to the system by providing the respective user name and password to the base station 1. This can therefore constitute the request for shift details as the base station 1 will determine that the user wishes to view shifts by virtue of the fact that they have logged on. The log on procedure will be described in more detail below with respect to FIG. 6.

Once the user has logged on and thereby requested shift details the base station 1 selects one or more appropriate shifts by any suitable means at step 250. In the case of the user being a locum, the shifts are selected so that the locum is only able to view shifts that he or she is qualified to work. Otherwise, in the case of an agency, details of all available shifts are provided. The process defined by steps 230 to 250 will be described in more detail below with respect to FIG. 6.

In any event, an indication of the one or more appropriate shifts is transferred from the base station 1 to the end station 3 by any suitable means at step 260. This may include brief details of the shift such as the time, location and relevant field, for example. Alternatively, the indication may include all the details of the shift, and typically whether brief or all details are displayed is an option that can be set by the user.

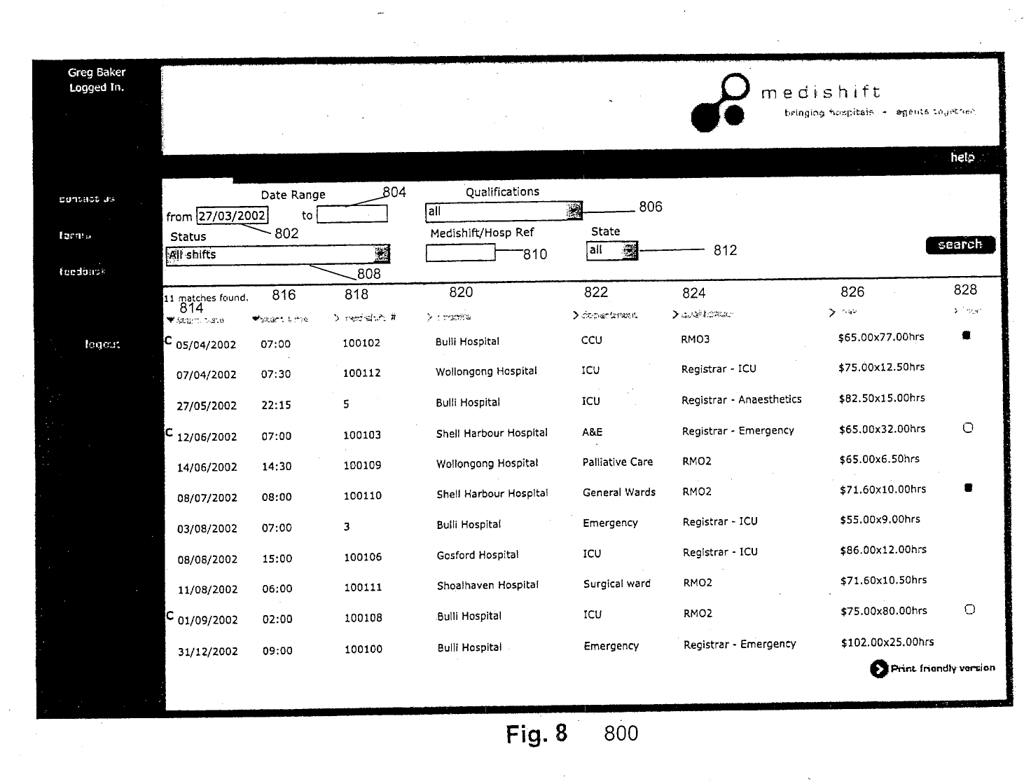

The shift details are displayed to the user on the end station 3 at step 270. Again, this is typically achieved using an appropriate web page, or other suitable means. An example of a web page 800 presenting the shift details for a number of example shifts is shown in FIG. 8. The user selects a date range 802 and 804 for the shifts of interest, the qualifications 806 to be included, the status of the shifts 808, the hospital reference number 810, and the state of interest 812. In this example, it can be seen that the user is provided with details regarding the shift start date 814, start time 816, medishift number 818 (a reference number that is unique for the shift), the hospital name 820, the department 822, the minimum level of qualification required for the shift 824, the pay 826, and whether the shift has been filled 828.

In general the indication of each shift may be provided as a hyper- or active scripting link, which when highlighted by the user will provide the user with additional information regarding the shift. Accordingly, if only brief details are displayed, the user can then select shifts of interest allowing further details of these shifts to be displayed, thereby allowing the user to determine if the shift is suitable for the locum, as will be appreciated by persons skilled in the art.

It can also be seen that the web page includes a search feature that allows the user to specify restrictions on the shifts that are to be displayed. This optional procedure is shown in dotted lines at steps 280 and 290.

As shown, if the user wishes to limit the number of shifts that are displayed, the user specifies restrictions such as the time or location of the shift, the type of work the shift relates to, or the like by any suitable means at step 280. The restrictions are transferred to the base station by any suitable means at step 290, which will then operate to determine one or more appropriate shifts in accordance with the defined restrictions at step 250. The shift details will then be transferred to the end station and displayed, as described above with respect to steps 260 and 270.

At step 300 the user selects a shift to be worked by any suitable means. Thus, if the user is a locum, this will correspond to a shift the locum wishes to work. Alternatively, if the user is an agent, this will correspond to a shift to which the agent is able to assign a locum. Accordingly, the agency will assess the criteria associated with the shift and determine if a suitable locum is available at this time. This will therefore involve checking the locum's qualifications against those specified for the shift.

As described above, the entity is able to define the qualifications in such a way that the procedural medical skills required by a particular level of locum may vary depending on the nature, and in particular, the location and time of the shift. Thus for example, if the shift is provided in the emergency or intensive care wards, an RMO 2 doctor may require IV cannulation skills in addition to normal RMO 2 requirements. Accordingly, in this case, the shift details will simply indicate RMO 2 for the shift. However, the shift details will also include an option allowing the user to view any additional requirements associated with the shift.

Accordingly, in this instance, the agency would examine the definition of RMO 2 and determine that this requires IV cannulation in addition to the normal requirements. In this case, the agency will therefore check that the locum they are intending to assign to this position is both RMO 2 qualified and has IV cannulation experience.

It will be appreciated that in the case of the user being a locum, this form of checking is performed in advance by the base station, as will be described with reference to FIG. 6. As a result, each locum is only be able to view shifts that they are capable of working.

Once the user has selected a shift, the user uses the end station 3 to generate a shift selection indicating the respective shift by any suitable means at step 310. This is usually achieved by selecting a hyperlink, or other suitable means, associated with the shift to be worked.

It will be appreciated that in the event that user is the locum, then the base station 1 will already be aware of the locum identity from the log-on procedure. However, if the user is an agency, then the agency will need to provide at least some details of the locum together with the shift selection. These details are provided to allow the base station 1 to assign the locum to the shift.

As mentioned above, the agency may have already verified the locum's ability to work the shift, for example, by checking the locum's qualifications, or the like. In this case, the minimum amount of information that is required by the base station I includes at least the locum's name, and usually the medical registration number. This allows the base station 1 to perform basic checking and allow entity notification of shift assignment. Thus, the base station 1 will typically provide the entity with the locum's name and medical registration number to allow the entity to identify the locum.

However, the entity may wish for the base station 1 to perform some additional checking, in which case the agency may need to provide additional details regarding the locum. This could include for example, having the base station 1 check the locum's criminal record, qualifications, or the like. In this case, this could be performed in a manner similar to that described below with respect to FIG. 6, when the user is the locum.

In any event, the entity will generally require further information regarding the locum to allow the entity to assess whether the locum is acceptable, as will be described in more detail below. Accordingly, in this case, the agency may need to provide additional locum details to the entity. This can be achieved by submitting the details to the base station 1 for subsequent transfer to the entity. Alternatively, the agency can forward the information directly to the entity, for example, via fax or other suitable means.

An indication of the shift selection is transferred to the base station 1 by any suitable means at step 320, with any provided locum details being stored as locum data in the database 12. At step 330 the base station I modifies the shift data to indicate that the accepted shift is no longer available at step 330 by any suitable means. This will typically be achieved by having the base station 1 set appropriate fields or like within the shift data. In any event, the effect of this is that the shift is now identified as being filled, and as a result, details of the shift will no longer be displayed to users of the system, thereby preventing a different user from attempting to fill the shift.

At step 340 the base station 1 transfers an indication of the shift selection and the locum by any suitable means to the end station 3A, allowing the entity to determine if the locum is acceptable by any suitable means at step 350. The information transferred will depend on the actual implementation of the system. However, generally the information will include at least an indication of the filled shift, together with the locum name.

In the case in which the user is the locum, or in which the agency has submitted details of the locum to the base station 1, then the base station will also transfer the locum details to the entity. Otherwise, the base station 1 will indicate to the entity that the additional locum details will be received directly from the agency. This may be achieved for example by having the agency transfer the details to the entity, for example, by fax, e-mail, or other suitable means.

The entity then uses this information to accept or reject the locum. This will typically involve checking to see if the locum has been rejected by the entity before, or if the locum is known not to be good enough for the position, for example, due to previous work experience at the entity. The entity will also generally review a work history in the form of a resume or the like, to allow the entity to assess the locum's suitability for working the shift.

As shown in FIG. 5C, if the locum is determined to be acceptable by any suitable means at step 360, then the entity generates an acceptance indication by any suitable means at step 370, using the end station 3A. The acceptance indication is transferred to the base station 1 by any suitable means at step 380. An indication of this is then transferred to the user at the end station 3 by any suitable means at step 390, allowing the user to determine that the locum is acceptable. The base station 1 also modifies the shift data to indicate that the locum is accepted and that the shift is filled by any suitable means at step 400, with the locum working the shift at step 410.

In this case, the locum or agency will generally need to know that the locum is accepted within a predetermined tine period, such that, in the event that the locum is not accepted, alternative placements can be arranged. Accordingly, the entity is generally required to provide the acceptance notification within a predetermined time limit.

In the event that the locum is rejected, the entity generates a rejection indication using the end station 3A by any suitable means at step 420, which is passed onto the base station 1 by any suitable means at step 430. An indication of the rejection is then transferred on to the user end station 3 by any suitable means at step 440, thereby informing the user of the rejection.

In general the entity will be requested to provide a reason for the rejection within the rejection notification. The locum or user can then use this reason to assess why the locum was rejected. This allows the locum to either address the issue, or select more suitable shifts in future, thereby helping to reduce the number of times locums are rejected in future.

Thus for example, a particular entity may be unhappy with a locum and unwilling to accept the locum for any shifts in future. By indicating this in the rejection notification, the entity avoids having the locum apply for any further shifts in future.

The base station 1 also operates to update the shift data stored in the database by any suitable means at step 450, thereby indicating that the shift is available again, allowing the shift to be located during subsequent searches. This allows an alternative locum to be assigned to the shift.

The log-on procedure and associated checking of the locum by the base station 1 during steps 230 to 250 will now be described with reference to FIG. 6.

Firstly, at step 500, the user uses the end station 3 to access the user interface generated by the base station 1 by any suitable means, which is usually in the form of a log-on or home page, or the like. The user then provides their user name and password by any suitable means at step 5 10.

At step 520, the base station 1 uses the user name to access user data by any suitable means, which indicates the user name and associated password for the respective user, and which is stored in the database 12. This allows the base station to determine if the user is a valid user by any suitable means at 530 and 540. If the user name and password combination is not valid, the user is denied access to the services of the base station 1 at step 550.

Otherwise, the base station 1 determines whether the user is a locum or an agency by any suitable means at steps 560 and 570. If the user is an agency, the base station 1 determines that the agency is to be presented with shift details of all available shifts at step 580, with the agency then verifying they their prospective locum meets all shift requirements by any suitable means. Accordingly, the base station will determine details of currently available shifts and transfer the shift details to the end station 3 at step 250 in FIG. 5A.

Otherwise, the base station 1 determines any validation indications associated with the user data by any suitable means at step 590. Validation indications are indications provided with selected ones of the locum details that require some form an additional level of checking, such as an independent check of the locum's details with an appropriate authority. This may include for example checking the locum's criminal record with the Police, or checking for certifications with a certification authority. In general, the validation criteria will be defined by operators of the base station 1, although additional requirements may be specified by the entity.

The base station 1 generally performs the checking required to validate the locum details. This may involve simply reviewing documentation, such as certificates, or the like. Alternatively, an operative of the base station 1 may have to contact an authority, such as the police or a certification or examination body to determine that the details provided by the locum are correct.

In any event, when the locum initially submits the locum details, during the registration procedure, a validation indication is generated. The validation indication is a time stamp that is stored together with appropriate user data in the database 12. From this, it will be appreciated that it is not generally possible for the locum to immediately satisfy the validation criteria when the locum details are submitted for the first time. Instead the locum will have to wait sufficient time for the details to be checked and the validation indications generated before the locum can use the system.

Accordingly, when the base station checks the validation criteria by any suitable means at step 600, the base station 1 examines the time stamp and compares this to a predetermined threshold which is set depending on the respective criteria. This threshold indicates the length of time for which the validation of the locum's details is accepted before the locum details need to be rechecked.

Thus, for example, in the case of a police check, the time stamp threshold may be set at six months so that independent verification of the locum's criminal record must be obtained every six months. Other criteria, such as professional indemnity insurance, medical registration, and any certifications, will also be checked in a similar manner.

If the timestamp has expired and is therefore older than the indicated threshold, this indicates that the locum's details need further verification. Accordingly, if the validation has expired at step 600, the locum is rejected at step 610, with a indication that the locum is unable to work until the validation indication is renewed, being transferred to the end station 3 from the base station 1.

Otherwise, the locum is accepted at step 600. At this point, the base station determines one or more criteria from the locum details by any suitable means at step 620. These criteria are then compared to the shift details by any suitable means at step 630 to allow the base station to determine one or more appropriate shifts by any suitabl means at step 640.

These criteria are generally criteria relating to the experience and qualifications of the locum that will have an impact on those shifts that the locum is permitted to work. Thus for example, if the locum is a doctor classed as an RMO 2 locum, then the search will locate all those available shifts that are of RMO 2 or below, and which the locum is therefore qualified to work.

In addition to simply checking the qualification level, the base station 1 may also operate to check if the locum has any required additional specific medical procedural experience. Thus, for example, the entity may have specified that the RMO 2 qualification additionally requires that the locum can perform IV cannulation, as described above. Accordingly, in this case, the base station 1 will obtain details of any additional requirements associated with the qualifications from the entity data. The base station 1 will then check not only that the locum is RMO 2 qualified, but also that the locum is capable of IV cannulation.

This means that when a locum accesses the list of available shifts, the locum is only presented with details of those shifts that the locum is able to work. Any shifts not presented at this stage will be shifts that the locum is unable to work for some reason. Thus, for example, when the experience requirements for the shift are checked, the requirements may include the ability to perform certain procedures as listed for example in Appendix A. If the locum has not indicated that they are able to perform the respective procedure, they will never be informed that the shift is available. This therefore ensures that locums are not able to accept and work shifts for which they do not meet the entities specified requirements.

However, the restriction of shift details on the basis of specific procedural medical skills may be applied with a degree of flexibility to ensure that shifts are filled. Thus, for example, in some circumstances, the base station 1 may adapted to select the shifts for display to the locum solely on the basis of the locum's qualifications and not in accordance with specific procedural requirements. This may occur, for example, if there are problems filling the shift.

Thus, for example, the system may vary the comparison based on the time until the shift is due to start. In this case, when the shift is initially posted on the system, the base station 1 will check both qualifications, and procedural requirements. If however, the shift remains unfilled either after a predetermined period, or within a predetermined time of the shift start, this will indicate that it may not be possible to obtain a locum with the specified requirements. Accordingly, from this point onwards, the base station 1 will only check the qualifications.

In the event that a locum views a shift for which they do not have requested skills, then the locum will be able to determine this from the shift details, which will allow the locum to view any additional procedural medical requirements for the shift. This allows the locum to consider whether they are willing to work the shift, knowing that they may have problems performing some tasks and therefore require additional supervision. However, from the entities point of view this will be preferable to the shift remaining unfilled.

A further option is for the entities and locums to specify different levels of experience with the procedures. Thus, a locum may be inexperienced for a certain skill. In this case, the shift will initially be offered to skilled workers, and then offered to less experienced workers only after a predetermined time period has elapsed and the shift remains unfilled.

It will therefore be appreciated that during this first stage, the number of shifts displayed is limited by the shifts the locum can work. However, as described above, the locum can then further define search criteria that allow the number of shifts shown to be limited by personal preference in addition to their suitability.

A further point is in the case of the end station user being an agency, the majority of the locum suitability checking is often performed by the agency itself. Accordingly, in this case, the full locum details provided to the entity by the agency, either through the system or direct to the agency by fax, email or other suitable means, facilitates the entity deciding whether to accept or reject the locum.

However, it will be appreciated that it is also possible for the base station 1 to perform similar checking for locums assigned to shifts by an agency. This may occur either in addition to, or instead of the agencies own checks. In any event, in this case, it would generally be necessary for the agency to provide locum details together with the shift selection, to allow the base station 1 to perform the comparisons as outlined above.

It will therefore be further appreciated that the agency may be required to ensure that validation indications are obtained for locums to allow the locums to be assigned to shifts using the system, although this is of course not essential depending on the implementation.

A number of additional features are also suitably implemented with the present invention.

Compound Shifts

The above techniques can also be applied to compound shifts that are formed from a number of related shifts at a given entity. Thus, for example, compound shifts generally involve performing the same work at the same entity over a number of shifts. Each shift in the compound shift will therefore have the same shift criteria subject only to variations in the shift time, and will generally be worked by the same locum. As a result, the compound shift could be handled in a manner identical to that described above.

In this case, instead of entering details of the shift start and end time, the entity would generally provide details of the start time of the first shift in the compound shift, together with an indication of the end time of the last shift.

Billing

The system is also suitably adapted to perform automatic billing of the entities and users of the system. In general revenue is generated by charging the entities for posting details of the shift on a per shift basis. Accordingly, the base station will retain entity data in the database 1 indicating when shifts were placed on the system by the entities. This allows the base station to examine the entity data at predetermined time intervals, and generate an invoice for the entity. It will be appreciated that entity data can indicate the amount the locum is to be paid for each shift, allowing the charge to be determined on a percentage basis.

Similarly, the locums and agencies may also be required to pay fees, such as on the basis of the number of shifts accepted, or on a subscription basis, and accordingly, the base station 1 can also monitor usage by the agencies or locums to generate invoices accordingly.

In contrast to this, billing between the locum, the hospitals and the agencies will not be handled by the base station 1, but rather will be sorted out between these parties themselves. However, the base station I can be adapted to generate reports, as outlined below, which can be used in aiding this process.

Reports

The system also suitably uses the data stored regarding the allocation of shifts to generate reports. The reports can be provided to entities, agents or locums to allow the respective entity, agent or locum to determine the number of shifts allocated for them by the system.

This information can then be used by the agencies for example when calculating any fees owed to them by the entities. Similarly the entities can use the reports to determine how efficient the system is at assigning locums to their shifts, as well as confirm the level of payments to both the base station 1 and the agencies.

An example of a report generated for a hospital is shown in Appendix B, with an example of a report generated for an agency being shown in Appendix C. A number of variations on the above techniques are also feasible.

Thus, for example, whilst the description focuses on the use of the system for assigning locums, such as doctors, nurses, and other allied health workers, to medical shifts, the techniques could also be applied to other industries. In this case, the information provided would have to be tailored for the respective industry, to allow the qualifications checks that are performed by the base station 1 to be appropriate to the relevant industry.

The system is also suitably used for the provision of permanent jobs. However, in this case, it may not be suitable to simply accept the first applicant for a respective position as the potential employer will generally want to review a number of candidates and select a preferred one. In contrast, in the above example, the most important thing is being able to ensure that some one is available to work a shift at short notice. Accordingly, the entity is generally less concerned about selecting from a choice of possible locums.

Furthermore, in the example described above, the system is implemented by having users access web-pages generated by the base station 1 using the end stations 3. However, a number of variants to this are possible.

Firstly, the base station 1 may generate WAP pages, or the like, which can be accessed via users of the system from a mobile phone, suitably adapted PDA, or other suitable means.

Secondly, the base station 1 is suitably adapted to provide details of shifts via email, SMS, MMS, or other suitable means. Thus, for example, the user could generate an e-mail, SMS, MMS, or the like, requesting details of shifts. The e-mail will act as the shift request, causing the base station 1 to determine a number of suitable shifts, as described above. Details of these suitable shifts will then be transferred to the user, via e-mail, SMS, or other suitable means. The remainder of the process will be substantially as hereinbefore described, with communication being via SMS and/or e-mail, or other suitable means, instead via web-pages.

Thirdly, the system can be implemented a number of different architectures. Thus, for example, the system could be implemented using a customized network capable application executed by the end stations 3, 3A. Thus, it will be appreciated that it is not necessary to use web pages or be restricted to a particular communication protocol. Instead, custom applications software operating on an IP or Microsoft Netbeui network, can be used to accesses the base station 1.

A further embodiment is for the base station to notify the users when suitable shifts become available. This form of operation is sometimes known as a “push” mode of operation as the base stations 1 “pushes” details of appropriate shifts to the users when suitable shifts are available. In this case, the base station 1 is adapted to compare the shift criteria to the details of each locum each time a new shift is received from an entity. This procedure would allow the base station to determine each locum that is registered with the system and that is capable of working the shift. The base station can then notify these locums using for example, SMS, MMS, or e-mail communications, such that each suitable locum is aware of the shift as soon as possible.

In this case, the user will generally have to provide an indication to the base station 1 when registering that e-mail or similar notification of shifts is to occur. Accordingly, in this case, the user will effectively generate a single shift request, requesting details of shifts as and when they are available. The base station 1 will then respond to this single shift request to provide details of any suitable shifts as they become available.

This in turn will enable locums to respond to available shifts in a shorter amount of time, thereby allowing the shifts to be filled more quickly. This can be achieved for example by having the locum send a reply SMS or e-mail, with the reply being interpreted by the base station 1 as a shift selection for the respective shift.

In this case, an indication of each shift may need to be transferred to the agencies, to allow the agencies to find a locum to fill the shift. This may be achieved by having the base station 1 generate an e-mail on a regular basis, the e-mail including a list of all new shifts (or any shifts that were deemed filled, but for which the entity has rejected the locum so that the shift is again available) added to the system since the previous e-mail. This would therefore typically be repeated every 24 hours, or the like, so that the agency receives a daily list of new shifts available on the system.

In this case, the users may also be able to register a more detailed profile as the shift request, thereby indicating additional details of the shifts that are to be notified to the user by e-mail. Thus, for example, a user may indicate that they wish to see each shift they are qualified to work from a respective entity as soon as details of the shift are received. Shifts from other entities, which may be of less interest to the user, can then be searched online in the manner described above with respect to FIGS. 1 to 8.

Persons skilled in the art will appreciate that numerous variations and modifications will become apparent. All such variations and modifications which become apparent to persons skilled in the art, should be considered to fall within the spirit and scope that the invention broadly appearing before described.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

[image]

[image]

[image]

[image]

What is claimed is:

1. A method for allocating at least one locum to an available shift using a distributed computing system, the method comprising the steps of:
receiving a shift request from a remote user;
accessing selected shift data stored in a memory, the shift data representative of at least one shift, wherein the shift data includes at least one of an entity associated with each shift, a predetermined time period for each shift, and specified work associated with each shift;
determining the availability of at least one shift in response to the shift request based on the shift data;
transmitting the availability of at least one shift to the remote user;
receiving at least one shift selection from the remote user;
assigning a locum to the shift in accordance with the received shift selection;
modifying the shift data in accordance with the received shift selection to indicate the shift is no longer available; and
transmitting the received shift selection and assigned locum information to at least one of the entity associated with the shift selection and the remote user.

2. The method according to claim 1 further comprising the steps of:
receiving selected information about a shift from the entity associated with the shift; and
generating shift data for such shift in accordance with the received information.

3. The method according to claim 1 further comprising the step of receiving selected information about a locum from the remote user.

4. The method according to claim 3 further comprising the steps of:
transmitting the selected information about the locum with the received shift selection and assigned locum to the entity; and
determining, by the entity, if the entity accepts the assigned locum based on the selected information about the locum.

5. The method according to claim 4 further comprising the steps of:
transmitting the entity determination of whether the entity accepts the assigned locum to at least one of the memory and the remote user;
if the entity does not accept the assigned locum, modifying the shift data to indicate the shift is available.

6. The method according to claim 5 further comprising the step of: if the entity does accept the assigned locum, modifying the shift data to indicate the shift has been filled.

7. The method according to claim 1 further comprising the steps of:
receiving selected user information from a remote user; and
accessing selected locum data stored in a memory in response to the received user information, the locum data representative of at least one locum and including selected data associated with each locum.

8. The method according to claim 7 further comprising the steps of:
receiving selected locum information from a remote user in connection with a shift request;
determining the availability of at least one shift in response to at least one of the received locum information, received shift request, and locum data; and
transmitting the availability of at least one shift to the remote user.

9. The method according to claim 8 wherein the step of determining the availability of at least one shift comprises the steps of:
comparing selected locum data with selected shift data to determine if the locum satisfies predetermined criteria for each shift; and
selecting shifts for which the locum satisfies the predetermined criteria.

10. The method according to claim 7 further comprising the steps of:
determining, based on the user information, if the remote user is authorized to access the locum data; and
if the remote user is authorized to access the data, determining the type of user.

11. The method according to claim 10 further comprising the step of: if the user is determined to be an agency, allowing the user to access shift data for all available shifts.

12. The method according to claim 10 further comprising the steps of:
if the user is determined to be an locum, determining if at least one validation criteria is associated with the locum;
if at least one validation criteria is associated with the locum, determining if the validation criteria has expired; and
if the validation criteria has expired, denying access to the locum.

13. The method according to claim 10 wherein the validation criteria include qualification requirements, lack of criminal record, indemnity insurance, and medical certification standing.

14. The method according to claim 1 further comprising the steps of:
receiving data from the remote user if the assigned locum is able to work the selected shift;
if the received data indicates that the assigned locum is unable to work the selected shift, accessing selected locum data, the locum data representative of at least one locum and including selected data associated with each locum accessing locum data;
determining an alternative locum to be assigned to the selected shift based on the locum data; and
transmitting information about the alternate locum to at least one of the remote user and the entity associated with the shift.

15. A system for allocating at least one locum to an available shift using a distributed computing system, the system comprising:
means adapted for receiving a shift request from a remote user;
a memory for storing selected shift data, the shift data representative of at least one shift, wherein the shift data includes at least one of an entity associated with each shift, a predetermined time period for each shift, and specified work associated with each shift;
means adapted for accessing the selected shift data;
means adapted for determining the availability of at least one shift in response to the shift request based on the shift data;
means adapted for transmitting the availability of at least one shift to the remote user;
means adapted for receiving at least one shift selection from the remote user;
means adapted for assigning a locum to the shift in accordance with the received shift selection;
means adapted for modifying the shift data in accordance with the received shift selection to indicate the shift is no longer available; and
means adapted for transmitting the received shift selection and assigned locum information to at least one of the entity associated with the shift selection and the remote user.

16. The system according to claim 15 further comprising:
means adapted for receiving selected information about a shift from the entity associated with the shift; and
means adapted generating shift data for such shift in accordance with the received information.

17. The system according to claim 15 further comprising means adapted receiving selected information about a locum from the remote user.

18. The method according to claim 17 further comprising:
means adapted for transmitting the selected information about the locum with the received shift selection and assigned locum to the entity; and
means adapted for determining, by the entity, if the entity accepts the assigned locum based on the selected information about the locum.

19. The system according to claim 18 further comprising:
means adapted for transmitting the entity determination of whether the entity accepts the assigned locum to at least one of the memory and the remote user;
if the entity does not accept the assigned locum, means adapted for modifying the shift data to indicate the shift is available.

20. The system according to claim 19 further comprising, if the entity does accept the assigned locum, means adapted for modifying the shift data to indicate the shift has been filled.

21. The system according to claim 15 further comprising:
means adapted for receiving selected user information from a remote user;
a memory for storing selected locum data, the locum data representative of at least one locum and including selected data associated with each locum; and
accessing selected locum data in response to the received user information.

22. The system according to claim 21 further comprising:
means adapted for receiving selected locum information from a remote user in connection with a shift request;
means adapted for determining the availability of at least one shift in response to at least one of the received locum information, received shift request, and locum data; and
means adapted for transmitting the availability of at least one shift to the remote user.

23. The system according to claim 22 wherein the means adapted for determining the availability of at least one shift comprises:
means adapted for comparing selected locum data with selected shift data to determine if the locum satisfies predetermined criteria for each shift; and
means adapted for selecting shifts for which the locum satisfies the predetermined criteria.

24. The system according to claim 21 further comprising:
means adapted for determining, based on the user information, if the remote user is authorized to access the locum data; and
if the remote user is authorized to access the data, means adapted for determining the type of user.

25. The system according to claim 24 further comprising, if the user is determined to be an agency, means adapted for allowing the user to access shift data for all available shifts.

26. The system according to claim 24 further comprising:
if the user is determined to be an locum, means adapted for determining if at least one validation criteria is associated with the locum;
if at least one validation criteria is associated with the locum, means adapted for determining if the validation criteria has expired; and
if the validation criteria has expired, means adapted for denying access to the locum.

27. The system according to claim 24 wherein the validation criteria include qualification requirements, lack of criminal record, indemnity insurance, and medical certification standing.

28. The method according to claim 15 further comprising:
means adapted for receiving data from the remote user if the assigned locum is able to work the selected shift;
a memory for storing selected locum data, the locum data representative of at least one locum and including selected data associated with each locum accessing locum data;
if the received data indicates that the assigned locum is unable to work the selected shift, means adapted for accessing selected locum data;
means adapted for determining an alternative locum to be assigned to the selected shift based on the locum data; and
means adapted fro transmitting information about the alternate locum to at least one of the remote user and the entity associated with the shift.

29. A computer-implemented method for allocating at least one locum to an available shift using a distributed computing system, the method comprising the steps of:
receiving a shift request from a remote user;
accessing selected shift data stored in a memory, the shift data representative of at least one shift, wherein the shift data includes at least one of an entity associated with each shift, a predetermined time period for each shift, and specified work associated with each shift;
determining the availability of at least one shift in response to the shift request based on the shift data;
transmitting the availability of at least one shift to the remote user;
receiving at least one shift selection from the remote user;
assigning a locum to the shift in accordance with the received shift selection;
modifying the shift data in accordance with the received shift selection to indicate the shift is no longer available; and
transmitting the received shift selection and assigned locum information to at least one of the entity associated with the shift selection and the remote user.

30. A computer-readable medium of instruction for allocating at least one locum to an available shift using a distributed computing system comprising:
means adapted for receiving a shift request from a remote user;
means adapted for accessing the selected shift data, the shift data representative of at least one shift, wherein the shift data includes at least one of an entity associated with each shift, a predetermined time period for each shift, and specified work associated with each shift;
means adapted for determining the availability of at least one shift in response to the shift request based on the shift data;
means adapted for transmitting the availability of at least one shift to the remote user;
means adapted for receiving at least one shift selection from the remote user;
means adapted for assigning a locum to the shift in accordance with the received shift selection;
means adapted for modifying the shift data in accordance with the received shift selection to indicate the shift is no longer available; and
means adapted for transmitting the received shift selection and assigned locum information to at least one of the entity associated with the shift selection and the remote user.
